(19) United States
(12) Patent Application Publication
(10) Pub. No.: US 2025/0249542 A1
(43) Pub. Date: Aug. 7, 2025

(54) METHOD WITH A TOOL PRESETTING AND/OR TOOL MEASURING APPARATUS, TOOL PRESETTING AND/OR TOOL MEASURING APPARATUS, TOOL CLAMPING DEVICE AND COMPUTER PROGRAM PRODUCT AND/OR COMPUTER PROGRAM COMPUTING INFRASTRUCTURE

(71) Applicant: E. ZOLLER GmbH & Co. KG Einstell- und Messgeraete, Pleidelsheim (DE)

(72) Inventors: Christian PFAU, Ingersheim (DE); Ali M. MANSOORY K., Pleidelsheim (DE)

(21) Appl. No.: 19/041,503

(22) Filed: Jan. 30, 2025

(30) Foreign Application Priority Data
Feb. 2, 2024 (DE) 10 2024 103 025.9

(51) Int. Cl. B23Q 17/24; G06V 10/56; G06V 10/764; G06V 10/776; G06V 20/60

(52) U.S. Cl. CPC B23Q 17/2457; G06V 10/56; G06V 10/764; G06V 10/776; G06V 20/60

(57) ABSTRACT

A method comprises at least one tool presetting and/or tool measuring apparatus for presetting and/or measuring tools in tool chucks or comprises at least one tool clamping device for clamping or unclamping tools in or from tool chucks, wherein, in at least one capturing step, one or more objects are captured in a field of view of a camera of the tool presetting and/or tool measuring apparatus or of the tool clamping device, and wherein, in at least one object recognition step, an image recognition algorithm is applied to camera images of the camera comprising the object/objects, wherein
the object recognition step is specifically configured at least for application to objects mentioned in the following list: tool, tool chuck, tool cutting edge, mounted complete tool, tool and/or tool chuck pallet.

### CROSS-REFERENCE TO RELATED APPLICATION

This patent application is a U.S. application based on and claiming priority to German patent application DE 10 2024 103 025.9, filed on Feb. 2, 2024, the contents of which are incorporated herein by reference.

### PRIOR ART

The invention relates to a method, a tool presetting and/or tool measuring apparatus, a tool clamping device and a computer program product and/or a computer program computing infrastructure.

A method with at least one tool presetting and/or tool measuring apparatus for presetting and/or measuring tools in tool chucks or with at least one tool clamping device for clamping or unclamping tools in or from tool chucks has already been proposed, wherein, in at least one capturing step, one or more objects are captured in a field of view of a camera of the tool presetting and/or tool measuring apparatus or of the tool clamping device, and wherein, in at least one object recognition step, an image recognition algorithm is applied to camera images of the camera comprising the object/objects.

The objective of the invention is, in particular, to provide a generic device having advantageous properties with regard to operator comfort. The objective is achieved according to the invention.

### Advantages of the Invention

The invention is based on a method, in particular a computer-implemented method, preferably a computer-implemented object recognition method, with at least one tool presetting and/or tool measuring apparatus for presetting and/or measuring tools in tool chucks or with at least one tool clamping device for clamping or unclamping tools in or from tool chucks, wherein, in at least one capturing step, one or more objects are captured in a field of view of a camera of the tool presetting and/or tool measuring apparatus or of the tool clamping device, and wherein, in at least one object recognition step, an image recognition algorithm is applied to camera images of the camera comprising the object/objects.

It is proposed that the object recognition step is specifically configured at least for application to objects mentioned in the following list, preferably to one or more objects mentioned in the following list and preferably to all objects mentioned in the following list: tool, tool chuck, tool cutting edge, mounted complete tool and tool and/or tool chuck pallet. As a result, operator comfort can advantageously be increased. Advantageously, the operator can be assisted in the operation of the tool presetting and/or tool measuring apparatus and/or of the tool clamping device. As a result, the operation can advantageously be simplified, accelerated and/or made more operationally reliable. Furthermore, a control function checking the operator inputs can advantageously be implemented for further increasing the operational reliability.

A “tool presetting and/or tool measuring apparatus” is to be understood in particular to mean an apparatus which is at least configured to at least partially capture and/or set at least one length, at least one angle, at least one contour and/or at least one outer shape of a tool. Preferably, the tool presetting and/or tool measuring apparatus has a presetting and/or measuring precision in the range of micrometers or below. A “tool clamping device” is to be understood in particular to mean an apparatus which is configured to mount a tool into a tool chuck and/or to dismount a tool from a tool chuck. In particular, the tool clamping device forms a tool clamping and/or tool unclamping unit. In particular, the tool clamping device is configured to activate, in particular preset, a clamping mechanism of a tool chuck and/or to deactivate, in particular release, the clamping mechanism of the tool chuck. For example, the tool clamping device can be embodied as a shrink clamping device. However, alternative clamping mechanisms which can be actuated by the tool clamping device, such as a hydraulic expansion clamping mechanism, a collet clamping mechanism, a union nut clamping mechanism, etc., are likewise conceivable. The tools are embodied in particular as shank tools, preferably as rotary shank tools, for example drills, milling cutters, profile tools and/or reamers, wherein preferably a shank of the shank tools is configured for mounting in a tool receptacle. A “tool chuck” is to be understood in particular to mean a component which is configured to receive a tool and to connect the tool to a machine. In particular, the tool chuck is embodied as an interface between the tool and the machine. For example, the tool chuck is embodied as a shrink chuck, as a hydraulic expansion chuck, as a press chuck, as a collet chuck or the like. “Configured” is to be understood in particular to mean specifically programmed, designed and/or equipped. The fact that an object is configured for a specific function is to be understood in particular to mean that the object fulfills and/or carries out this specific function in at least one application state and/or operating state. The camera is embodied in particular as a reflected-light camera of the tool presetting and/or tool measuring apparatus or of the tool clamping device. Alternatively or additionally, use of a transmitted-light camera is also conceivable. Preferably, the image recognition algorithm is an object recognition algorithm. The object recognition algorithm is embodied as an object recognition algorithm known to a person skilled in the art from the prior art. A list of known object recognition methods on the basis of image data can be found inter alia in the online lexicon “Wikipedia” (https://en.wikipedia.org/wiki/Outline_of_object_recognition, Status: Revision vom 30.10.2023-12:14Uhr).

In particular, an image recognition algorithm specifically configured for application to a specific object type is at least able to distinguish the corresponding object type from other object types. Preferably, the image recognition algorithm specifically configured for application to the specific object type is at least able to distinguish and in particular categorize different objects of the corresponding object type from one another. The capacities of the image recognition algorithm/object recognition algorithm substantially go beyond a simple recognition of wall thicknesses, sizes, lengths, widths or of outer contours. The tool cutting edge is in particular a chip-removing part of a working region of a tool. A complete tool comprises in particular a combination of tool chuck and tool specifically matched to one another and/or belonging together, which in particular can be removed. A tool and/or tool chuck pallet is embodied in particular as a planar holding device and/or storage device for holding and/or storing tools and/or tool chucks, which preferably comprises a plurality of columns and/or rows of receiving locations for tools and/or tool chucks.

In a further aspect of the invention, which can be considered on its own or also in combination with at least one, in particular in combination with one, in particular in combination with any number of the other aspects of the invention, it is proposed that, in the object recognition step, it is determined by means of the image recognition algorithm whether the object/objects captured by the camera is/are in each case an individual tool, an individual tool chuck, a tool cutting edge, a mounted complete tool or a tool and/or tool chuck pallet, and wherein, in at least one output step, at least one information, in particular an identification information, relating to each specific object is output electronically or visually. As a result, high user comfort can advantageously be achieved. Advantageously, the user can be assisted in the operation of the tool presetting and/or tool measuring apparatus and/or of the tool clamping device, as a result of which in particular a working speed and/or an operational reliability can be increased. In particular, the image recognition algorithm/object recognition algorithm is configured for an individual recognition of objects of one or more of the object types mentioned. In particular, the image recognition algorithm/object recognition algorithm is configured for distinguishing the object types mentioned. The output information is in particular machine-readable and/or understandable/interpretable for the operator. A machine-readable output comprises in particular the digital output of the information as a code which can be read in/understood by a computer program. The output information preferably comprises information about the captured object type, i.e. about the captured tool, e.g. its tool type, its designation and/or its compatibilities with tool chucks, about the captured tool chuck, e.g. its tool chuck type, its designation and/or its compatibilities with tools and/or machine tools, about the captured tool cutting edge, e.g. its cutting edge type, its designation and/or its compatibility with tools, about the captured mounted complete tool, e.g. its type and/or its designation, and/or about the captured tool and/or tool chuck pallet, e.g. its pallet type, its designation, its number of receiving positions, its receiving positions dimensioning(s) and/or its compatibilities for specific tools, tool chucks, tool presetting and/or tool measuring apparatuses and/or tool clamping devices. Advantageously, the recognition of the number of receiving positions and/or the receiving positions dimensioning(s) of the tool pallet/tool chuck pallet can be performed on the basis of an individual camera image captured by the camera. As a result, a high working speed can advantageously be achieved. In particular, it is additionally conceivable that a tool pallet/tool chuck pallet and the tools/tool chucks stored therein are captured in the object recognition step. On the basis of this information, a time can then be predicted which the (automated) tool presetting and/or tool measuring apparatus and/or the (automated) tool clamping device requires for processing the tool pallet/tool chuck pallet (e.g. taking into account working times of the device functions and handling times of manipulators for transporting the tools and/or tool chucks, such as grippers, etc.). As a result, work planning, an efficiency and/or a working speed can advantageously be substantially improved. It is conceivable that a pallet for receiving tools and tool chucks is simultaneously provided, i.e. has receiving positions for tools and tool chucks. The object recognition step can also be applied to such pallets (tool and tool chuck pallets). In this case, the image recognition algorithm is configured for distinguishing between receiving positions types of the pallet.

It is additionally proposed that, in the object recognition step, an object category is determined which comprises at least one tool type of an object recognized as a tool, a tool cutting edge type of an object recognized as a tool cutting edge, a tool chuck type of an object recognized as a tool chuck, a complete tool type of an object captured as a complete tool and/or a pallet type of an object captured as a tool and/or tool chuck pallet, and in that, in the output step, the tool type, the tool cutting edge type, the tool chuck type, the complete tool type and/or the pallet type relating to each specific object is output electronically or visually. As a result, high user comfort can advantageously be achieved. Advantageously, the user can be assisted in the operation of the tool presetting and/or tool measuring apparatus and/or of the tool clamping device, as a result of which in particular a working speed and/or an operational reliability can be increased. In particular, the different tool types, tool cutting edge types, tool chuck types, complete tool types and/or pallet types also in each case comprise objects of identical classes, but of different sizes. For example, two otherwise identical shrink chucks of different sizes, that is to say for tool shanks of different sizes, thus also form different tool chuck types which can be distinguished by the image recognition algorithm. The respective types can be characterized, for example, by clearly distinguishable designations. The clearly distinguishable designations can then be output electronically or visually.

It is additionally proposed that the method comprises an evaluation step in which a compatibility or incompatibility of at least two of the objects recognized in the object recognition step with respect to one another, e.g. a tool and a tool chuck with respect to one another, a tool and a tool pallet with respect to one another, a tool chuck and a tool chuck pallet with respect to one another, a tool and a tool cutting edge with respect to one another, etc., is determined. As a result, a high operational reliability can advantageously be achieved. Advantageously, a risk of operating errors generated by inattentiveness of human operators can be reduced. For example, in the case of a recognition of an incompatibility, a machine-readable warning message and/or warning signal and/or a warning signal which can be perceived by sensors by the operator can be output. In the case of a recognition of a compatibility or incompatibility of tool and tool chuck with respect to one another, it can be determined, for example, whether or not a tool shank of the tool fits into a receiving opening of the tool chuck. In the case of a recognition of a compatibility or incompatibility of tool and tool cutting edge with respect to one another, it can be determined, for example, whether or not a tool cutting edge fits to a receiving point for removable tool cutting edges of the tool. In the case of a recognition of a compatibility or incompatibility of tool/tool chuck and tool pallet/tool chuck pallet with respect to one another, it can be determined, for example, whether or not a tool/a tool chuck fits into a receiving position of the tool pallet/the tool chuck pallet.

If, in the process, it is determined in the evaluation step whether at least two of the objects recognized as compatible with one another in the object recognition step are objects which can be releasably connected to one another, a faulty connection can advantageously be prevented and thus a risk of damage to the objects can be reduced. For example, tool and tool chuck can be releasably connected to one another. For example, tool and tool pallet can be releasably connected to one another. For example, tool chuck and tool chuck pallet can be releasably connected to one another. For example, tool cutting edge and tool can be releasably connected to one another.

If, therefore, it is now recognized in the evaluation step whether a tool shank of an object recognized as an individual tool is compatible with a further object recognized as an individual tool chuck, a miscombination of tool and tool chuck and thus damage to tool and/or tool chuck can advantageously be avoided.

If, therefore, it is now recognized in the evaluation step whether an object recognized as a tool cutting edge, in particular as an indexable cutting insert, is compatible with a further object recognized as an individual tool, a miscombination of tool and tool cutting edge and thus damage to tool and/or tool cutting edge can advantageously be avoided.

If, moreover, it is recognized in the evaluation step whether an object, for example an object recognized as a tool, as a tool chuck or as a tool cutting edge, matches a work planning present for the tool presetting and/or tool measuring apparatus or the tool clamping device, for example of a tool management system, a faulty planning of the objects can advantageously be prevented. As a result, a work result of the tool presetting and/or tool measuring apparatus or of the tool clamping device can advantageously be optimized. In addition, an operation of the tool presetting and/or tool measuring apparatus or of the tool clamping device can advantageously be optimized, in particular accelerated and/or facilitated. For example, on the basis of the transmission of the information about the recognized object to the tool presetting and/or tool measuring apparatus or to the tool clamping device, a presetting of the tool presetting and/or tool measuring apparatus or of the tool clamping device can already be performed, which then, for example, only has to be monitored and confirmed by the respective operator. The work planning, in particular the tool management system, comprises, for example, a planned sequence of objects processed in the respective apparatus.

It is proposed that, as a result, in the output step, a proposal for a change of the work planning or a direct change of the work planning is output if, in the evaluation step, a non-match of the currently recognized object with the present work planning has been determined. As a result, an interruption of an operating sequence can advantageously be avoided. A high efficiency can advantageously be achieved as a result.

Alternatively or additionally, it is proposed that, in the output step, a warning message is output and/or an operation of the tool clamping device is blocked if, according to the work planning, the currently present tool chuck would have to be a heat shrink chuck or if, according to the work planning, a subsequent heat shrink of the currently present tool chuck is planned, but, in the object recognition step, a different tool chuck type, in particular the tool chuck type of hydraulic expansion chuck, has been determined. As a result, a substantial increase in an operational reliability can advantageously be achieved. It can advantageously be prevented that tool chucks which cannot withstand heating are exposed to a heat shrink process. Hydraulic expansion chucks comprise, for example, closed chambers which are filled with hydraulic oil or the like and which can explode in the event of intense heating of the hydraulic expansion chucks. Such explosions can lead to injuries such as wounds, burns or hearing impairments (acoustic trauma), etc., in the case of persons located in a vicinity. By reducing a risk of such explosions in factory installations in which different tool chuck types are used, a risk of injury and/or damage can therefore advantageously be substantially reduced. Hydraulic expansion chucks and shrink chucks which are designed for similar or identical tools can frequently not be recognized by a sole check of individual features such as wall thicknesses, sizes, lengths, widths or outer contours, with the result that a use of the specifically configured image recognition algorithms and/or object recognition algorithms described, in particular assisted by artificial intelligence or machine learning, is associated here with very great safety improvements.

In addition, it is proposed that the object category is determined at least partially on the basis of a non-presence of certain features, in particular certain color features and/or certain black-and-white patterns or color patterns. As a result, a particularly reliable and/or particularly simple determination of the object category can advantageously be made possible. For example, an object category can be recognized on the basis of a non-presence of a QR code, in particular a QR code with a certain background color which is different from white, for example yellow, such as the so-called “zid code” from E. ZOLLER GmbH & Co. KG, Einstell-und Messgeräte (Pleidelsheim, Germany). For example, an object category can be recognized on the basis of a non-presence of an ID chip, such as, for example, an RFID chip, in particular an RFID chip from Balluff GmbH (Neuhausen auf den Fildern, Germany) which forms a square black box. In particular, the determination of the non-presence contributes to the determination of the object category in addition to one or more further recognition features.

In addition, it is proposed that the object category is determined at least partially on the basis of a color recognition, in particular a tool cutting edge color, a tool chuck color, a tool color or a complete tool color. As a result, a particularly reliable and/or particularly simple determination of the object category can advantageously be made possible. In particular, the color recognition contributes to the determination of the object category in addition to one or more further recognition features.

In addition, it is proposed that the object category is determined at least partially on the basis of a physical dimension. As a result, a particularly reliable and/or particularly simple determination of the object category can advantageously be made possible. In particular, the determination of the physical dimension contributes to the determination of the object category in addition to one or more further recognition features.

In addition, it is proposed that the object category is determined at least partially on the basis of a finding of typical optical wear phenomena and/or typical soiling of the object, in particular of the tool cutting edge, of the tool chuck or of the tool. As a result, a particularly reliable and/or particularly simple determination of the object category can advantageously be made possible. In particular, the finding of typical optical wear phenomena and/or typical soiling of the object contributes to the determination of the object category in addition to one or more further recognition features. For example, the optical wear phenomenon can be a discoloration of a surface generated by an (e.g. inductive) heating of shrink regions of heat shrink chucks. This discoloration can then contribute to the recognition of heat shrink chucks, in particular with particularly high reliability. For example, the optical wear phenomenon can be a characteristic surface change, e.g. scratch trace or the like, generated by a typical use of the object. For example, the typical soiling can be a soiling generated by an auxiliary means used during the use of the object, such as e.g. a lubricant or the like. For example, the typical soiling can be a label or inscription residue found at a typical point of the object, which is applied to the object at least temporarily during a typical use of the object.

Moreover, it is proposed that, in at least one work step, a user of the tool presetting and/or tool measuring apparatus or of the tool clamping device is automatically displayed an operating mask and/or operating surface of the tool presetting and/or tool measuring apparatus or of the tool clamping device, said operating mask and/or operating surface matching the determined object category or categories of the currently present object(s), preferably already being at least partially filled. As a result, an operating comfort, a working speed and/or an operational reliability can advantageously be significantly increased.

If the image recognition algorithm is embodied as a machine learning algorithm trained specifically on the recognition of tools, tool chucks, tool cutting edges, mounted complete tools and/or tool and/or tool chuck pallets, in particular using known deep learning techniques, a particularly high precision of the object recognition can advantageously be achieved. As a result, the advantageous effects already described above, such as speed, operational reliability and/or operating comfort, can be further intensified. The machine learning algorithm is preferably trained specifically on the recognition of tools, in particular from a defined group of tools, of tool chucks, in particular from a defined group of tool chucks, of mounted complete tools, in particular from a defined group of mounted complete tools and/or of tool and/or tool chuck pallets, in particular from a defined group of tool and/or tool chuck pallets. The machine learning algorithm is preferably a machine learning algorithm specialized on a recognition of objects from camera images. The object recognition from images is one of the main disciplines of machine learning, such that the training and/or the application of corresponding machine learning algorithms lies in the field of the specialist knowledge of a person skilled in the art (see, inter alia, the article of the online lexicon Wikipedia already referenced further above). If the trained machine learning algorithm, in particular based on an application of a deep learning technique, is a CNN (convolutional neural network) algorithm, in particular advantages can be achieved during a processing of larger data quantities in the course of the object recognition on the basis of the camera images. In addition, advantages can also be achieved as a result in an object recognition of suboptimal camera images which have image distortions and/or different illumination conditions. In addition, a memory space requirement can advantageously be kept low in comparison with other neural networks. For example, one of the known CNN algorithms described in the following publications can be used in the tool identification method: a) AlexNet: Alex Krizhevsky, Imagenet classification with deep convolutional neural networks, Communications of the ACM 60.6, pg. 84-90 (2017); b) MobileNet: Andrew G. Howard, MobileNets: Efficient Convolutional Neural Networks for Mobile Vision Applications, CoRR, abs/1704.04861, (2017); c) Xception: Francois Chollet, Xception: Deep Learning with Depthwise Separable Convolutions, CoRR, abs/1610.02357, (2016); d) LeCun Y, Bengio Y, Hinton G (2015) Deep learning; Nature 521:436{444, DOI 10.1038/044539; e) Lin H, Li B, Wang X, Shu Y, Niu S (2019); Automated defect inspection of LED chip using deep convolutional neural network; J Intell Manuf; 30:2525{2534, DOI 10.1007/s10845-018-1415-x; f) Fu G, Sun P, Zhu W, Yang J, Cao Y, Yang M Y, Cao Y (2019); A deep-learning-based approach for fast and robust steel surface defects classification; Opt Laser Eng 121:397{405, DOI 10.1016/j.optlaseng.2019.05.005; g) Lee K B, Cheon S, Kim C O (2017) A Convolutional Neural Network for Fault Classification and Diagnosis in Semiconductor Manufacturing Processes; IEEE T Semiconduct M 30: 135{142, DOI 10.1109/TSM.2017.2676245; h) Goncalves D A, Stemmer M R, Pereira M (2020) A convolutional neural network approach on bead geometry estimation for a laser cladding system; Int J Adv Manuf Tech 106:1811{1821, DOI 10.1007/s00170-019-04669-z; i) Karatas A, Kölsch D, Schmidt S, Eier M, Seewig J (2019) Development of a convolutional autoencoder using deep neuronal networks for defect detection and generating ideal references for cutting edges; Munich, Germany, DOI 10.1117/12.2525882; j) Stahl J, Jauch C (2019) Quick roughness evaluation of cut edges using a convolutional neural network; In: Proceedings SPIE 11172, Munich, Germany, DOI 10.1117/12.2519440; or k) a CNN of the open source framework known under the name “TensorFlow”. Alternative CNN algorithms which are known to a person skilled in the art, such as, for example, Region Proposals (R-CNN, Fast R-CNN, Faster R-CNN), Detectron, Single Shot MultiBox Detector (SSD) or You Only Look Once (YOLO, for example in the version number 8 which can be licensed at the time of registration), etc., are of course likewise conceivable. For the application of many of these machine learning algorithms, simple open-source solutions are available (cf. the article from the online lexicon “Wikipedia” already referenced above). In particular, the trained machine learning algorithm is executed by a computing unit which can be part of the tool presetting and/or tool measuring apparatus or of the tool clamping device or which can be arranged separately therefrom. A “computing unit” is to be understood in particular to mean a unit having an information input, an information processing and an information output. Advantageously, the computing unit has at least one processor, a memory, input and output means, further electrical components, an operating program, regulation routines, control routines and/or calculation routines. Preferably, the components of the computing unit are arranged on a common circuit board and/or are advantageously arranged in a common housing. Alternatively, however, the computing unit can also be embodied as a distributed computing unit, such as, for example, a cloud. In particular, the trained machine learning algorithm comprises an object classification algorithm.

The trained machine learning algorithm has preferably been trained in advance, in particular before the use in the described method, specifically on the performance of the object recognition step, in particular for the application to the mentioned objects, for the recognition of the mentioned objects, for the recognition of the mentioned object categories and/or for the recognition of the mentioned compatibilities and/or incompatibilities (“offline learning”). This initial training preferably takes place in an initial training step or offline training step preceding the method. In the offline training step, firstly a multiplicity of camera images of the tools, tool chucks, tool cutting edges, mounted complete tools and/or tool and/or tool chuck pallets configured for the application of the object recognition step are generated, preferably from different perspectives, but in particular at least from the perspective which the camera also adopts in later use. In these camera images, boundaries around each of these objects contained therein are then preferably drawn. This can be done manually, for example. Each of the drawn boundaries is then preferably assigned a label. The camera images processed in this way are then preferably divided into three groups: a training group, a validation group and a test group. Subsequently, the groups of processed camera images are input into the machine learning algorithm, in particular specialized on an object recognition, e.g. YOLOv8. The machine learning algorithm then performs, in particular in a known manner, an offline training on the basis of this input and thereby becomes in particular the image recognition algorithm and/or object recognition algorithm which can perform the object recognition step claimed/described above.

It is additionally proposed that the method comprises a training step, in which the machine learning algorithm is further trained by a feedback, in particular operator feedback, confirming, correcting or dementing the information output in the output step (“online learning”). As a result, a particularly high object recognition, which is further optimized in particular in the course of the method application, can advantageously be achieved. The above-mentioned advantages of the object recognition can advantageously be further intensified as a result. It is conceivable that, for the capturing of the feedback, the determined information about the object is displayed to the operator by the tool presetting and/or tool measuring apparatus or the tool clamping device, in particular in the output step, and a continuation or (unchanged) confirmation of the indication of the operator is regarded as a positive (confirming) feedback to the machine learning algorithm, while a revision of the displayed information or a request to repeat the object recognition is regarded as a negative (correcting or dementing) feedback to the machine learning algorithm. A continuous learning/optimization of the machine learning algorithm is then performed on the basis of these positive and negative feedbacks.

Furthermore, it is proposed that the machine learning algorithm has an anomaly recognition function for recognizing anomalies, in particular optically recognizable anomalies, in the objects captured during the capturing step in the field of view of the camera. As a result, a high operational reliability can advantageously be achieved. It is conceivable that, in the case of a recognition of an anomaly, a work planning, for example of a tool management system, is changed or that an operation of the tool presetting and/or tool measuring apparatus or of the tool clamping device is paused until the anomaly has been checked by an operator. An anomaly can be embodied, for example, by an unexpected or particularly large soiling. An anomaly can be embodied, for example, by an adhesive label or a remainder of a partially removed adhesive label or by adhesive residues of an adhesive label. In particular in the case of a shrink chuck, such an anomaly in the shrink region can lead to substantial damage to the shrink chuck (e.g. by a burning/burning-in of the soiling). An anomaly can be embodied, for example, by a damage to the object, such as, for example, a crack, a breakout, a deformation, an absence of a part, etc.

In addition, it is proposed that the camera used for carrying out the capturing step is additionally used for carrying out at least one core task of the tool presetting and/or tool measuring apparatus or of the tool clamping device. As a result, a high efficiency and/or a cost-effectiveness can advantageously be achieved. A synergistic additional effect can advantageously be added to the already existing camera. The camera of the tool presetting and/or tool measuring apparatus used for carrying out the capturing step is embodied in particular as the camera, preferably reflected-light camera, which is also configured for a measurement of tools, tool chucks and/or complete tools by the tool presetting and/or tool measuring apparatus.

Furthermore, a tool presetting and/or tool measuring apparatus having at least one camera, in particular a presetting and/or measuring camera, and having at least one computing unit is proposed, wherein at least the computing unit is configured at least with the aid of the camera, in particular the presetting and/or measuring camera, for carrying out the method described above, in particular the computer-implemented method, preferably the computer-implemented object recognition method. Alternatively or additionally, a tool clamping device having at least one camera, in particular a presetting and/or measuring camera, and having at least one computing unit is proposed, wherein at least the computing unit is configured at least with the aid of the camera, in particular the presetting and/or measuring camera, for carrying out the method described above, in particular the computer-implemented method, preferably the computer-implemented object recognition method. As a result, operator comfort can advantageously be increased. Advantageously, the operator can be assisted in the operation of the tool presetting and/or tool measuring apparatus and/or of the tool clamping device.

In addition, a computer program product and/or a computer program computing infrastructure, comprising commands which, when the computer program is executed by a computing unit, preferably of the tool presetting and/or tool measuring apparatus or of the tool clamping device, cause said computing unit to carry out the steps of the method described above, in particular the computer-implemented method, preferably the computer-implemented object recognition method, in particular with the machine learning algorithm, is proposed. As a result, operator comfort can advantageously be increased. Advantageously, the operator can be assisted in the operation of the tool presetting and/or tool measuring apparatus and/or of the tool clamping device.

The method according to the invention, the tool presetting and/or tool measuring apparatus according to the invention, the tool clamping device according to the invention and the computer program product according to the invention and/or the computer program computing infrastructure according to the invention are not intended to be restricted here to the application and embodiment described above. In particular, the method according to the invention, the tool presetting and/or tool measuring apparatus according to the invention, the tool clamping device according to the invention and the computer program product according to the invention and/or the computer program computing infrastructure according to the invention can have a number of individual elements, components and units differing from a number mentioned herein in order to fulfill a functionality described herein.

### DRAWINGS

Further advantages emerge from the following description of the drawings. An exemplary embodiment of the invention is illustrated in the drawings. The drawings, the description and the claims contain numerous features in combination. The person skilled in the art will expediently also consider the features individually and combine them to form meaningful further combinations.

In the drawings:

FIG. 1 shows a schematic perspective illustration of a tool presetting and/or tool measuring apparatus for carrying out a method,

FIG. 2 shows a schematic perspective illustration of a tool clamping device for carrying out the method,

FIG. 3 shows a schematic perspective illustration of an exemplary tool embodied as a hobbing milling cutter,

FIG. 4 shows a schematic perspective illustration of an indexable cutting insert with a tool cutting edge,

FIG. 5 shows a schematic plan view of an exemplary tool and/or tool chuck pallet, and

FIG. 6 shows a schematic flow diagram of the method.

### DESCRIPTION OF THE EXEMPLARY EMBODIMENT

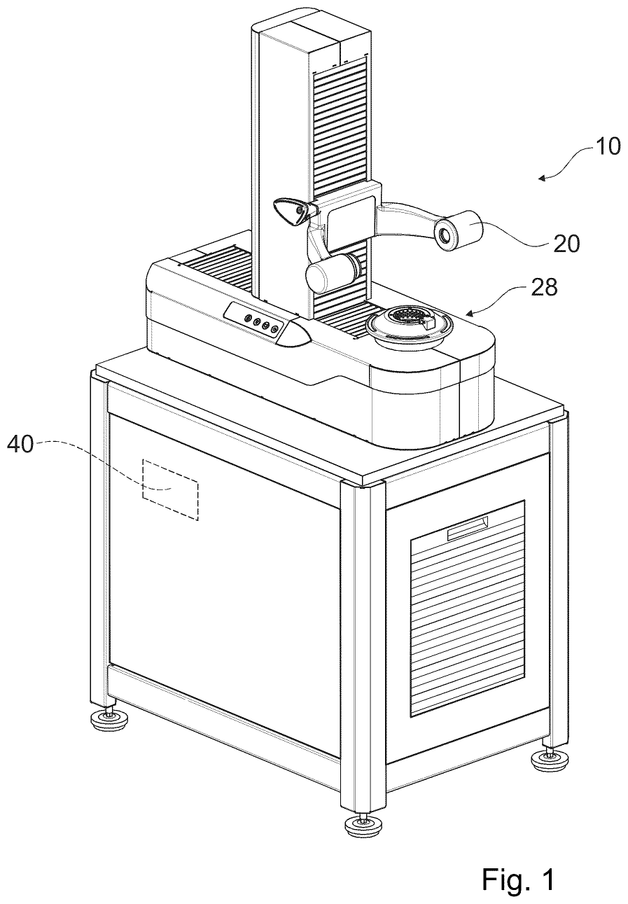

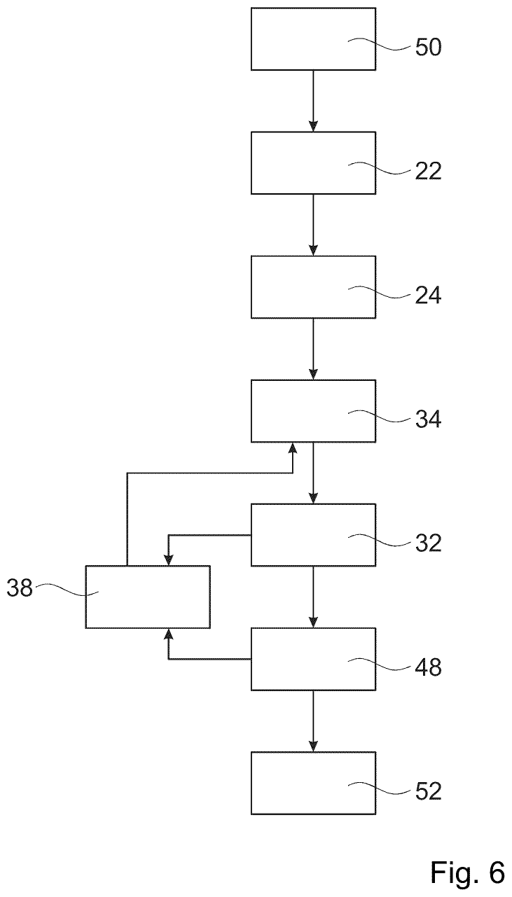

FIG. 1 shows a schematic perspective illustration of a tool presetting and/or tool measuring apparatus 10. The tool presetting and/or tool measuring apparatus 10 has a camera 20. The camera 20 forms a presetting and/or measuring camera of the tool presetting and/or tool measuring apparatus 10. The camera 20 is configured at least for carrying out a measuring method/a measurement function of the tool presetting and/or tool measuring apparatus 10. The camera 20 is a reflected-light camera. The tool presetting and/or tool measuring apparatus 10 has a holding device 28. The tool presetting and/or tool measuring apparatus 10 has a computing unit 40, in particular a computer. In FIG. 1, the computing unit 40 is embodied in an exemplary manner integrated into the tool presetting and/or tool measuring apparatus 10, in particular embodied in one piece with a computing unit 40 of the tool presetting and/or tool measuring apparatus 10. Alternatively, the computing unit 40 could also be embodied separately from the tool presetting and/or tool measuring apparatus 10 and be connected to the tool presetting and/or tool measuring apparatus 10 (e.g. cloud computing). The computing unit 40 is configured at least with the aid of the camera 20 for carrying out a method described in connection with FIG. 6, in particular a computer-implemented method, preferably a computer-implemented object recognition method, in particular by means of a machine learning algorithm. The computing unit 40 comprises a stored computer program product. The computer program product could also be stored on external data carriers or in a computer program computing infrastructure. The computer program product comprises a computer program with commands which, when executed by the computing unit 40, cause said computing unit to carry out the steps of the method described. The computer program product comprises a computer program with commands which, when executed by the computing unit 40, cause said computing unit to carry out the machine learning algorithm for recognizing objects 18 in camera images of the camera 20.

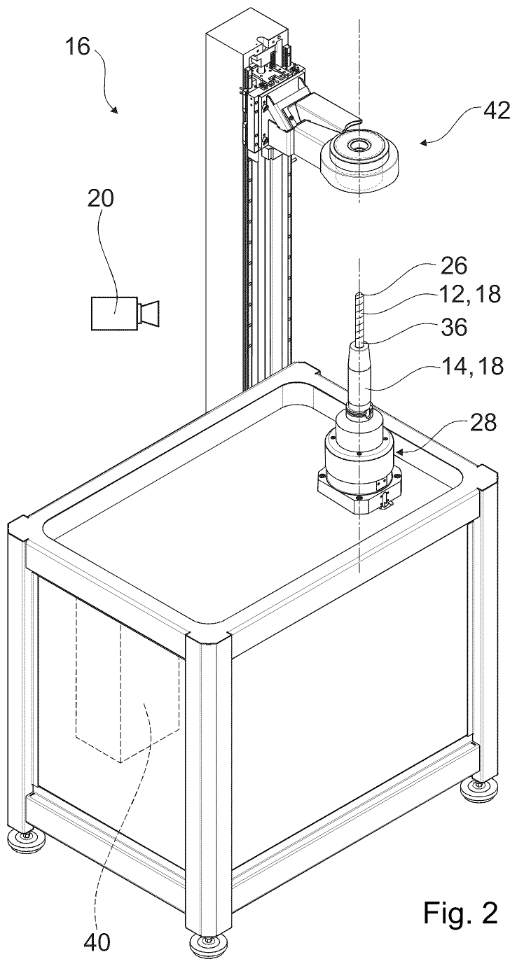

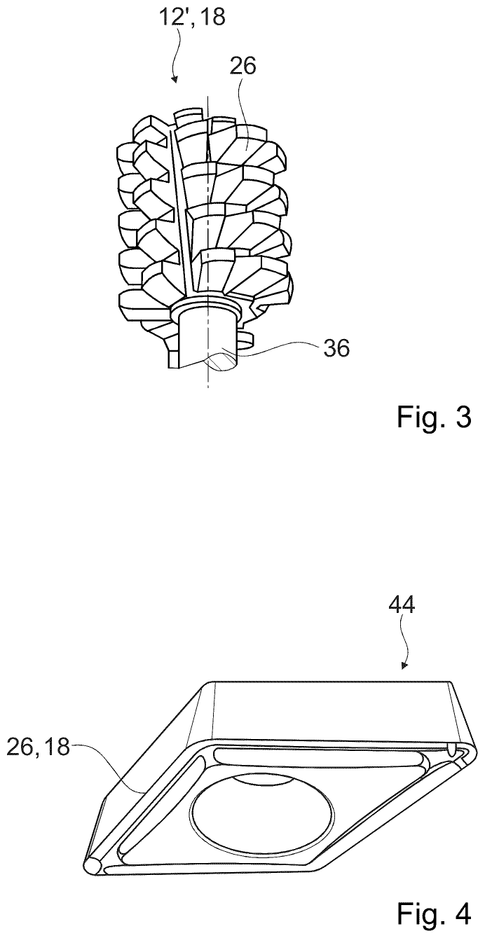

FIG. 2 shows a schematic perspective illustration of a tool clamping device 16. The tool clamping device 16 likewise has a camera 20. The tool clamping device 16 likewise has a computing unit 40 comprising the properties mentioned above. The tool clamping device 16 is embodied by way of example as a shrink clamping device with an induction coil unit 42 for heating clamping regions of tool chucks 14 embodied as heat shrink chucks. The tool clamping device 16 likewise has a holding device 28. The holding device 28 is configured for holding the tool chucks 14. Alternatively or additionally, the holding device 28 could also be configured for holding tools 12. Moreover, the holding device 28 could be configured for holding mounted complete tools (not illustrated, but substantially but similarly to the illustrated mounted combination of tool 12 and tool chuck 14 of FIG. 2) or a tool 12 of a removed complete tool or a tool chuck 14 of a removed complete tool. In the case illustrated in FIG. 2, a tool 12 is mounted into the tool chuck 14 positioned in the holding device 28. In the case illustrated by way of example, the tool 12 is embodied as a shank tool, in particular as a drilling tool having a tool shank 36 and a cutting region with a tool cutting edge 26. FIG. 3 schematically illustrates by way of example an alternative tool 12′ embodied as a hobbing milling cutter. The hobbing milling cutter has a plurality of tool cutting edges 26. In the case of the tools 12, 12′ illustrated by way of example, the tool cutting edges 26 are inseparably connected to the remainder of the tool 12, 12′. Alternatively or additionally, however, tool cutting edges 26 which can be removed from the remainder of the tool 12, 12′, for example in the form of indexable cutting inserts 44 (cf. FIG. 4), are also conceivable. FIG. 4 shows by way of example a schematic perspective illustration of an indexable cutting insert 44 with a tool cutting edge 26.

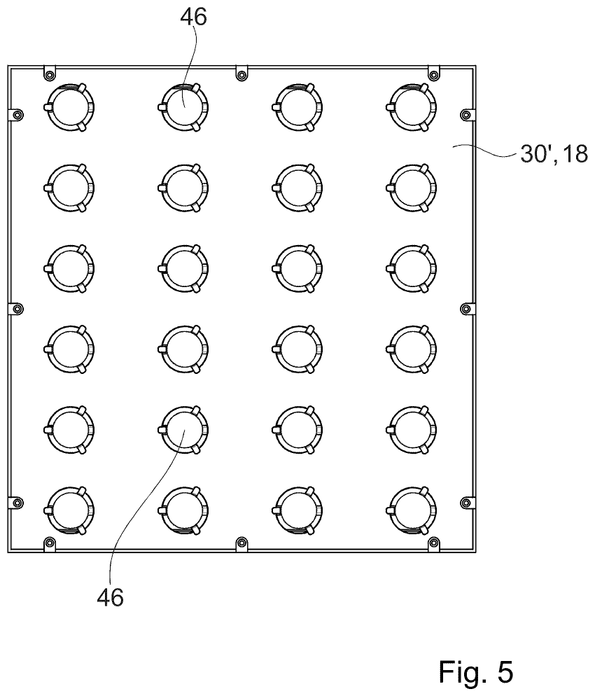

Alternatively or additionally, it is additionally conceivable that the holding device 28 of the tool presetting and/or tool measuring apparatus 10 or of the tool clamping device 16 is configured for holding a tool and/or tool chuck pallet 30. FIG. 5 shows a schematic plan view of an exemplary tool and/or tool chuck pallet 30. The tool and/or tool chuck pallet 30 comprises a plurality of holding places 46 for holding tools 12 and/or tool chucks 14. The holding places 46 of the tool and/or tool chuck pallet 30 are arranged in a common plane. The holding places 46 of the tool and/or tool chuck pallet 30 can be arranged in ordered rows and columns as in the example of FIG. 5.

FIG. 6 shows a schematic flow diagram of a method with the tool presetting and/or tool measuring apparatus 10. The tool presetting and/or tool measuring apparatus 10 is configured for presetting and/or measuring the tools 12, 12′ in the tool chuck/chucks 14. The method can alternatively also be carried out with the tool clamping device 16. The tool clamping device 16 is configured for clamping or unclamping the tools 12, 12′ in or from the tool chuck/chucks 14. The method is a computer-implemented method. The method is a computer-implemented object recognition method. In at least one method step 50, one or more objects 18 are brought into a field of view of the camera 20 of the tool presetting and/or tool measuring apparatus 10 or of the tool clamping device 16.

In at least one capturing step 22, the object/objects 18 is/are captured in the field of view of the camera 20 by the camera 20. The camera 20 used for carrying out the capturing step 22 is preferably additionally used for carrying out at least one core task of the tool presetting and/or tool measuring apparatus 10 or of the tool clamping device 16. In the capturing step 22, the camera 20 creates camera images of the object/objects 18. In at least one object recognition step 24, an image recognition algorithm is applied to the camera images of the camera 20 comprising the object/objects 18. The object recognition step 24 is specifically configured at least for application to one or more, preferably all, of the objects 18 mentioned in the following list: a) tool 12, 12′, b) tool chuck 14, c) tool cutting edge 26, d) mounted complete tool, e) tool and/or tool chuck pallet 30. In the object recognition step 24, it is determined by means of the image recognition algorithm whether each of the objects 18 captured by the camera 20 is in each case an individual tool 12, 12′, an individual tool chuck 14, a tool cutting edge 26, a mounted complete tool or a tool and/or tool chuck pallet 30. The image recognition algorithm can thus distinguish at least one object 18 embodied as a tool 12, 12′ from other objects 18 not embodied as a tool 12, 12′. The image recognition algorithm can thus distinguish at least one object 18 embodied as a tool chuck 14 from other objects 18 not embodied as a tool chuck 14. The image recognition algorithm can thus distinguish at least one object 18 embodied as a tool cutting edge 26, e.g. indexable cutting insert, from other objects 18 not embodied as tool cutting edges 26. The image recognition algorithm can thus distinguish at least one object 18 embodied as a mounted complete tool from other objects 18 not embodied as mounted complete tools. The image recognition algorithm can thus distinguish at least one object 18 embodied as a tool and/or tool chuck pallet 30 from other objects 18 not embodied as tool and/or tool chuck pallets 30.

In the object recognition step 24, an object category is determined. The object category comprises at least one tool type of an object 18 recognized as a tool 12, 12′, a tool cutting edge type of an object 18 recognized as a tool cutting edge 26, a tool chuck type of an object 18 recognized as a tool chuck 14, a complete tool type of an object 18 captured as a complete tool and/or a pallet type of an object 18 captured as a tool and/or tool chuck pallet 30. The object category can be determined at least partially on the basis of a non-presence of certain features, in particular certain color features and/or certain black-and-white patterns or color patterns. The object category can be determined at least partially on the basis of a color recognition, in particular a tool cutting edge color, a tool chuck color, a tool color or a complete tool color. The object category can be determined at least partially on the basis of a physical dimension. The object category can be determined at least partially on the basis of a finding of typical optical wear phenomena and/or typical soiling of the object 18, in particular of the tool cutting edge 26, of the tool chuck 14 or of the tool 12, 12′.

In an evaluation step 34, a compatibility or incompatibility of at least two of the objects 18 recognized in the object recognition step 24 with respect to one another is determined. In the object recognition step 24, a plurality of objects 18 can be captured simultaneously or successively on the basis of camera images. In the evaluation step 34, it is determined whether at least two of the objects 18 recognized as compatible with one another in the object recognition step 24 are objects 18 which can be releasably connected to one another. In the evaluation step 34, it is determined whether a recognized tool 12, 12′ is compatible with a recognized tool chuck 14, that is to say, for example, whether the tool shank 36 of the tool 12, 12′ fits into the tool chuck 14. In the evaluation step 34, it is determined whether a recognized tool cutting edge 26 matches a recognized tool 12, 12′, that is to say, for example, whether the tool cutting edge 26 can be mounted on the tool 12, 12′. In the evaluation step 34, it is determined whether a recognized tool 12, 12′, a recognized tool chuck 14 or a recognized mounted complete tool fits into one or more holding places 46 of a recognized tool and/or tool chuck pallet 30. In the evaluation step 34, it is additionally recognized whether an object 18, for example an object 18 recognized as a tool 12, 12′, as a tool chuck 14 or as a tool cutting edge 26, matches a work planning present for the tool presetting and/or tool measuring apparatus 10 or the tool clamping device 16, for example of a tool management system.

In at least one output step 32, at least one information relating to each specific object 18 is output electronically or visually. In the output step 32, an identification information relating to each specific object 18 is output electronically or visually. In the output step 32, the tool type, the tool cutting edge type, the tool chuck type, the complete tool type and/or the pallet type relating to each specific object 18 is output electronically or visually. The electronic output can be implemented for example as an output of a machine-readable code, for example to a machine tool. The visual output can be effected for example via a display unit (not illustrated), such as a screen, of the tool presetting and/or tool measuring apparatus 10 or of the tool clamping device 16. The visual output can be perceived visually by the respective operator. In the output step 32, a proposal for a change of the work planning, for example of the tool management system for one or more machine tools, for one or more tool clamping devices 16 or for one or more tool presetting and/or tool measuring apparatuses 10, or a direct change of the work planning is output if, in the previously performed evaluation step 34, a non-match of the currently recognized object 18 with an object 18 planned according to the present work planning has been determined. In the output step 32, a warning message is output if, according to the work planning, for example of the tool management system for one or more tool clamping devices 16, the currently present tool chuck 14 would have to be a heat shrink chuck, but, in the object recognition step 24, a different tool chuck type, in particular the tool chuck type of hydraulic expansion chuck, has been determined. In the output step 32, a warning message is output if, according to the work planning, for example of the tool management system for one or more tool clamping devices 16, a subsequent heat shrink of the currently present tool chuck 14 is planned, but, in the object recognition step 24, a different tool chuck type, in particular the tool chuck type of hydraulic expansion chuck, has been determined. Alternatively or additionally to the warning message, in the output step 32, the operation of the tool clamping device 16 is automatically blocked and/or paused.

In at least one work step 48, a user/operator of the tool presetting and/or tool measuring apparatus 10 or of the tool clamping device 16 is automatically displayed an operating mask and/or operating surface of the tool presetting and/or tool measuring apparatus 10 or of the tool clamping device 16, said operating mask and/or operating surface matching the determined object category or categories of the currently present object(s) 18. The operating mask can already be automatically partially filled in the work step 48.

The image recognition algorithm is embodied as a machine learning algorithm trained specifically on the recognition of tools 12, 12′, tool chucks 14, tool cutting edges 26, mounted complete tools and/or tool and/or tool chuck pallets 30. The trained machine learning algorithm is a CNN algorithm. The trained machine learning algorithm is an object recognition and/or object classification algorithm. The machine learning algorithm has an anomaly recognition function for recognizing optically recognizable anomalies in the objects 18 captured during the capturing step 22 in the field of view of the camera 20.

In a training step 38, the machine learning algorithm is further trained by a feedback confirming, correcting or dementing the information output in the output step 32. The feedback is an operator feedback. The operator can generate the operator feedback for example by means of a confirmation or rejection of the visual output or of the operating mask proposed in the work step 48.

In at least one method step 52, the tool presetting and/or tool measuring apparatus 10 or the tool clamping device 16 is operated using the information determined in the preceding steps of the method.

1. A method, in particular computer-implemented method, preferably computer-implemented object recognition method, with at least one tool presetting and/or tool measuring apparatus for presetting and/or measuring tools in tool chucks or with at least one tool clamping device for clamping or unclamping tools in or from tool chucks,
wherein, in at least one capturing step, one or more objects are captured in a field of view of a camera of the tool presetting and/or tool measuring apparatus or of the tool clamping device, and
wherein, in at least one object recognition step, an image recognition algorithm is applied to camera images of the camera comprising the object/objects,
wherein the object recognition step is specifically configured at least for application to objects mentioned in the following list:
tool,
tool chuck,
tool cutting edge,
mounted complete tool,
tool and/or tool chuck pallet.

2. The method according to claim 1, wherein the object recognition step, it is determined by means of the image recognition algorithm whether the object(s) captured by the camera is/are in each case an individual tool, an individual tool chuck, a tool cutting edge, a mounted complete tool or a tool and/or tool chuck pallet, and wherein, in at least one output step, at least one information, in particular an identification information, relating to each specific object is output electronically or visually.

3. The method according to claim 2, wherein, in the object recognition step, an object category is determined which comprises at least one tool type of an object recognized as a tool, a tool cutting edge type of an object recognized as a tool cutting edge, a tool chuck type of an object recognized as a tool chuck, a complete tool type of an object captured as a complete tool and/or a pallet type of an object captured as a tool and/or tool chuck pallet, and in that, in the output step, the tool type, the tool cutting edge type, the tool chuck type, the complete tool type and/or the pallet type relating to each specific object is output electronically or visually.

4. The method according to claim 3, comprising an evaluation step in which a compatibility or incompatibility of at least two of the objects recognized in the object recognition step with respect to one another is determined.

5. The method according to claim 4, wherein, in the evaluation step, it is determined whether at least two of the objects recognized as compatible with one another in the object recognition step are objects which can be releasably connected to one another.

6. The method according to claim 4, wherein, in the evaluation step, it is recognized whether a tool shank of an object recognized as an individual tool is compatible with a further object recognized as an individual tool chuck.

7. The method according to claim 4, wherein, in the evaluation step, it is recognized whether an object recognized as a tool cutting edge, in particular as an indexable cutting insert, is compatible with a further object recognized as an individual tool.

8. The method according to claim 4, wherein, in the evaluation step, it is recognized whether an object, for example an object recognized as a tool, as a tool chuck or as a tool cutting edge, matches a work planning present for the tool presetting and/or tool measuring apparatus or the tool clamping device, for example of a tool management system.

9. The method according to claim 8, wherein, in the output step, a proposal for a change of the work planning or a direct change of the work planning is output if, in the evaluation step, a non-match of the currently recognized object with the present work planning has been determined.

10. The method according to claim 8, wherein, in the output step, a warning message is output and/or an operation of the tool clamping device is blocked if, according to the work planning, the currently present tool chuck would have to be a heat shrink chuck or if, according to the work planning, a subsequent heat shrink of the currently present tool chuck is planned, but, in the object recognition step, a different tool chuck type, in particular the tool chuck type of hydraulic expansion chuck, has been determined.

11. The method according to claim 3, wherein the object category is determined at least partially on the basis of a non-presence of certain features, in particular certain color features and/or certain black-and-white patterns or color patterns.

12. The method according to claim 3, wherein the object category is determined at least partially on the basis of a color recognition, in particular a tool cutting edge color, a tool chuck color, a tool color or a complete tool color.

13. The method according to claim 3, wherein the object category is determined at least partially on the basis of a physical dimension.

14. The method according to claim 3, wherein object category is determined at least partially on the basis of a finding of typical optical wear phenomena and/or typical soiling of the object, in particular of the tool cutting edge, of the tool chuck or of the tool.

15. The method according to claim 3, wherein, in at least one work step, a user of the tool presetting and/or tool measuring apparatus or of the tool clamping device is automatically displayed an operating mask and/or operating surface of the tool presetting and/or tool measuring apparatus or of the tool clamping device, said operating mask and/or operating surface matching the determined object category or categories of the currently present object(s), preferably already being at least partially filled.

16. The method according to claim 1, wherein the image recognition algorithm is embodied as a machine learning algorithm trained specifically on the recognition of tools, tool chucks, tool cutting edges, mounted complete tools and/or tool and/or tool chuck pallets.

17. The method according to claim 16, comprising a training step, in which the machine learning algorithm is further trained by a feedback, in particular operator feedback, confirming, correcting or dementing the information output in the output step.

18. The method according to claim 16, wherein the machine learning algorithm has an anomaly recognition function for recognizing anomalies, in particular optically recognizable anomalies, in the objects captured during the capturing step in the field of view of the camera.

19. The method according to claim 1, wherein the camera used for carrying out the capturing step is additionally used for carrying out at least one core task of the tool presetting and/or tool measuring apparatus or of the tool clamping device.

20. A tool presetting and/or tool measuring apparatus having at least one camera, in particular a presetting and/or measuring camera, and having at least one computing unit, wherein at least the computing unit is configured at least with the aid of the camera, in particular the presetting and/or measuring camera, for carrying out the method, in particular the computer-implemented method, preferably the computer-implemented object recognition method, according to claim 1.

21. A tool clamping device having at least one camera and having at least one computing unit, wherein at least the computing unit is configured at least with the aid of the camera for carrying out the method according to claim 1.

22. A computer program product and/or computer program computing infrastructure, comprising commands which, when the computer program is executed by a computing unit, preferably of a tool presetting and/or tool measuring apparatus according to claim 20 or of a tool clamping device according to claim 21, cause said computing unit to carry out the steps of the method according to claim 1.

23. A computer-implemented object recognition method, with at least one tool presetting and/or tool measuring apparatus for presetting and/or measuring tools in the tool chucks or with at least one tool clamping device for clamping or unclamping tools in or from tool chucks,
wherein, at least one capturing step, one or more objects are captured in a field of view of a camera of the tool presetting and/or tool measuring apparatus or of the tool clamping device, and
wherein, in at least one object recognition step, an image recognition algorithm is applied to camera images of the camera comprising the object/objects,
wherein in the object recognition step, it is determined by means of the image recognition algorithm whether the object(s) captured by the camera is/are in each case an individual tool, an individual tool chuck, a tool cutting edge, a mounted complete tool or a tool and/or tool chuck pallet, and
wherein, in at least one output step, at least one information, in particular an identification information, related to each specific object is output electronically or visually.
